(19) United States
(12) Patent Application Publication
(10) Pub. No.: US 2009/0310784 A1
(43) Pub. Date: Dec. 17, 2009

(54) QKD System Alignment

(76) Inventors: Joanna Duligall, Gloucester (GB); Keith Harrison, Chepstow (GB); William Munro, Bristol (GB); Timothy Spiller, Bristol (GB); Radu Ionicioiu, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/469,571

(22) Filed: May 20, 2009

(30) Foreign Application Priority Data
May 21, 2008 (GB) 0809227.2

(51) Int. Cl. H04L 9/18; H04L 9/08

(52) U.S. Cl. 380/256; 380/278

(57) ABSTRACT

QKD receiving apparatus is provided with an alignment-correction system for correcting misalignment of a quantum signal received at an optical port of the apparatus relative to a quantum-signal detector of the receiving apparatus. The alignment-correction system comprises a misalignment measuring subsystem for making multiple different misalignment measures, and a misalignment compensation subsystem for adjusting the relative alignment of the quantum signal and quantum-signal detector in dependence on the misalignment measures made. The misalignment measuring subsystem comprises an alignment-beam source, an alignment-beam detector arrangement, and optical components for guiding an alignment beam from the alignment-beam source to the optical port, and for guiding the alignment beam, after external retro-reflection at a cooperating QKD transmitting apparatus from the optical port to the alignment-beam detector arrangement.

QKD methods and systems have been developed which enable two parties to share random data in a way that has a very high probability of detecting any eavesdroppers. This means that if no eavesdroppers are detected, the parties can have a high degree of confidence that the shared random data is secret. QKD methods and systems are described, for example, in U.S. Pat. No. 5,515,438, U.S. Pat. No. 5,999,285.

Whatever particular QKD system is used, QKD methods typically involve QKD transmitting apparatus 10 (see FIG. 1 of the accompanying drawings) using a QKD transmitter 12 to send a random data set provided by random source 11, over a quantum signal channel 5 to a QKD receiver 22 of QKD receiving apparatus 20. The QKD transmitting and receiving apparatus 10, 20 then respectively process the data transmitted and received via the quantum signal channel in respective processing sub-systems 13, 23 thereby to derive a common subset m of the random data set. This processing is done with the aid of messages exchanged between the processing sub-systems 13, 23 via an insecure classical communication channel 6 established between classical channel transceivers 14 and 24 of the transmitting and receiving apparatus 10, 20 respectively. As the quantum signal channel 5 is a noisy channel, the processing of the data received over that channel includes an error correction phase that relies on messages exchanged over the classical channel 6.

In most known QKD systems, the quantum signal is embodied as a stream of randomly polarized photons sent from the transmitting apparatus to the receiving apparatus either through a fiber-optic cable or free space; such systems typically operate according to the well-known BB84 quantum coding scheme (see C. H. Bennett and G. Brassard “Quantum Cryptography: Public Key Distribution and Coin Tossing”, Proceedings of IEEE International Conference on Computers Systems and Signal Processing, Bangalore India, December 1984, pp 175-179).

In such systems, the QKD transmitter 12 provides the optical components for selectively polarizing photons, and the QKD receiver 22 provides the optical components for receiving photons and detecting their polarization. Typically, these optical components establish two pairs of orthogonal polarization axes, the two pairs of polarization axes being offset by 45° relative to each other. Conventionally, these two pairs of polarization axes are referred to as vertical/horizontal and diagonal/anti-diagonal respectively. An example QKD transmitter 12 and QKD receiver 22 will now be described with reference to FIGS. 2 and 3 respectively of the accompanying drawings.

The QKD transmitter 12 of FIG. 2 comprises an array of light emitting diodes (LEDs) 15A-D in front of each of which is a respective polarizing filter 16A-16D. Filter 16A polarizes photons emitted from LED 15A vertically, filter 16B polarizes photons emitted from LED 15B horizontally, filter 16C polarizes photons emitted from LED 16C diagonally and filter 16D polarizes photons emitted from LED 16D anti-diagonally. Thus, each photon in the stream of photons coming away from the filters 16A-D, is polarized in one of four directions, these directions corresponding to two pairs of orthogonal polarization axes at 45° to each other. A fibre optic light guide 17 conveys the polarized photons out through a lens via a narrow band pass frequency filter 18 (for restricting the emitted photons to a narrow frequency range, typically plus or minus 1 nm), and a spatial filter 19 (for limiting light leakage outside the channel). An attenuation arrangement, not specifically illustrated, is also provided is to reduce the number of photons emitted; the attenuation arrangement may simply be an attenuating filter placed near the other filters or may take the form of individual power control circuits for regulating the power fed to each LED 15A to 15D when pulsed. Without the attenuation arrangement the number of photons emitted each time a LED is pulsed at normal levels would, for example, be of the order of one million; with the attenuation arrangement in place, the average emission rate is 1 photon per 10 pulses. Importantly this means that more than one photon is rarely emitted per pulse.

The FIG. 3 QKD receiver 22 comprises a lens 25, a quad-detector arrangement 30, and a fibre optic light guide 26 for conveying photons received through the lens 25 to the quad-detector arrangement 30. The quad-detector arrangement 30 comprises a beam splitter 31, a half-wave plate 36 for rotating the polarization of photons by 45°, a first paired-detector unit 32, and a second paired-detector unit 33. The first paired-detector unit 32 comprises a polarization-dependent beam splitter 34 and detectors 37A, 37B; the presence of the beam splitter 34 causes the polarizations detected by the detectors 37A and 37B to be mutually orthogonal. The second paired-detector unit 33 comprises a polarization-dependent beam splitter 35 and detectors 37C, 37D; the presence of the beam splitter 35 causes the polarizations detected by the detectors 37C and 37D to be mutually orthogonal. The polarization rotation effected by half-wave plate 36 causes the polarizations detected by the detectors 37A, 37B to be at 45° to those detected by the detectors 37C, 37D; more specifically, the paired detector unit 33 is arranged to detect horizontal/vertical polarizations whereas the paired detector unit 33 is arranged to detect diagonal/anti-diagonal polarizations.

The beam splitter 31 is depicted in FIG. 3 as half-silvered mirror but can be of other forms such as diffraction gratings. The polarization-dependent beam splitters 34, 35 are, for example, birefringent beam splitters.

Operation of the apparatus of FIGS. 1 to 3 in accordance with the BB84 protocol is generally as follows with the QKD transmitting apparatus 10 and QKD receiving apparatus being conventionally referred to as ‘Alice’ and ‘Bob’ respectively. It is assumed that Alice and Bob have a predetermined agreement as to the length of a time slot in which a unit of data will be emitted.

Alice randomly generates (using source 11) a multiplicity of pairs of bits, typically of the order of 10⁸ pairs. Each pair of bits consists of a data bit and a basis bit, the latter indicating the pair of polarization axes to be used for sending the data bit, be it vertical/horizontal or diagonal/anti-diagonal. A horizontally or diagonally polarized photon indicates a binary 1, while a vertically or anti-diagonally polarized photon indicates a binary 0. The data bit of each pair is thus sent by Alice over the quantum signal channel 5 encoded according to the pair of polarization directions indicated by the basis bit of the same pair. When receiving the quantum signal from Alice, Bob randomly chooses, by virtue of the action of the half-silvered mirror 31, which paired-detector unit 32, 33 and thus which basis (pair of polarization directions) it will use to detect the quantum signal during each time slot and records the results. The sending of the data bits of the randomly-generated pairs of bits is the only communication that need occur using the quantum channel 5.

Next, Bob sends Alice, via the classical channel 6, partial reception data comprising the time slots in which a signal was received, and the basis (i.e. pair of polarization directions) thereof, but not the data bit values determined as received.

Alice then determines a subset m of its transmitted data as the data bit values transmitted for the time slots for which Bob received the quantum signal and used the correct basis for determining the received bit value. Alice also sends Bob, via the classical channel 6, information identifying the time slots holding the data bit values of m. Bob then determines the data bit values making up the received data. The next phase of operation is error correction of the received data by an error correction process involving messages passed over the classical channel 6; after error correction, Bob's received data should match the data m held by Alice and this can be confirmed by exchanging encrypted checksums over the classical channel 6.

A requirement for the successful transmission of the quantum signal over the quantum signal channel 5 is that the quantum signal is correctly aligned with the quantum signal detector arrangement of the receiving apparatus 20, both directionally and such that the polarization directions of the transmitting and receiving apparatus 10, 20 have the same orientation. Where both the transmitting and receiving apparatus 10, 20 are fixed in position, this is not a major issue as alignment need only be effected once, that is, at the time the apparatus is installed. However, where one or both apparatus 10, 20 are movable, alignment is a greater issue as it will need to be done repeatedly.

For example, the QKD transmitting apparatus may take the form of a hand-held device intended to cooperate with fixed receiving apparatus; one possible scenario where this could be the case is depicted in FIG. 4. More particularly, in FIG. 4 a user 100 is shown holding a hand-held QKD transmitting device 10 to interface with a QKD receiving apparatus 20 incorporated into a bank ATM (Automatic Teller Machine) 101. The QKD transmitting device 10 and QKD receiving device 20, enable the user and the ATM to establish a shared secret key which can be used to encrypt transaction messages passed between them, for example, over the classical communication channel used by the QKD system.

In cases, such as that depicted in FIG. 4, in which a hand-holdable transmitting apparatus is intended to cooperate with fixed receiving apparatus, quantum signal alignment can be achieved by using a mounting cradle or similar physical structure configured to seat the transmitting apparatus in a particular orientation. With the cradle appropriately fixed in position in front of the receiving apparatus 20 (the cradle can, for example be manufactured as an integral part of the structure of the receiving apparatus 20), when the transmitting apparatus 10 is correctly seated in the cradle the desired alignment between the QKD transmitting and receiving apparatus 10 and 20 is achieved.

Instead of using a cradle, an active alignment system can be provided that uses an alignment channel between the transmitting and receiving apparatus to generate alignment adjustment signals for use in aligning the transmitting apparatus 2 and the receiving apparatus 4; example active alignment systems for a hand-held QKD transmitting apparatus are disclosed in US published application 20070025551 (Assignees: Hewlett-Packard Development Company, and The University of Bristol, UK).

### DESCRIPTION OF THE DRAWINGS

Embodiments of the invention will now be described, by way of non-limiting example, with reference to the accompanying diagrammatic drawings of the prior art and of an embodiment of the invention, in which:

FIG. 1 is a diagram of a known QKD system;

FIG. 2 is a diagram of a QKD transmitter of the FIG. 1 system;

FIG. 3 is a diagram of a QKD receiver of the FIG. 1 system;

FIG. 4 is a diagram illustrating the use of a hand-held QKD transmitting device with a fixed QKD receiving apparatus;

FIG. 5 is a diagram depicting roll, pitch and yaw rotations of a hand-held QKD transmitting device;

FIG. 6 is a diagram illustrating an optical channel for a received quantum signal in a QKD receiving apparatus embodying the invention;

FIG. 7 is a diagram depicting a misalignment measuring subsystem of the QKD receiving apparatus subject of FIG. 6;

FIG. 8 is a diagram depicting a misalignment compensation subsystem of the QKD receiving apparatus subject of FIG. 6;

FIG. 9 is a diagram showing in combination the features depicted in FIGS. 6 to 8 of the QKD receiving apparatus embodying the invention.

### DETAILED DESCRIPTION

FIG. 5 depicts, for a hand-held QKD transmitting device 10, a reference coordinate system with three orthogonal axes X, Y and Z, the Z axis being aligned with the optical axis of the device 10, that is, the axis of the quantum signal.

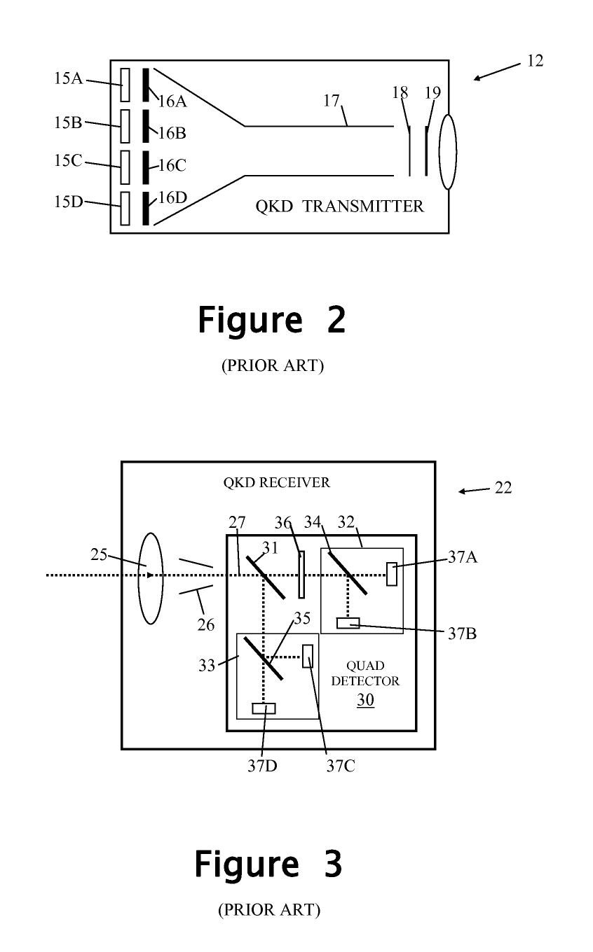

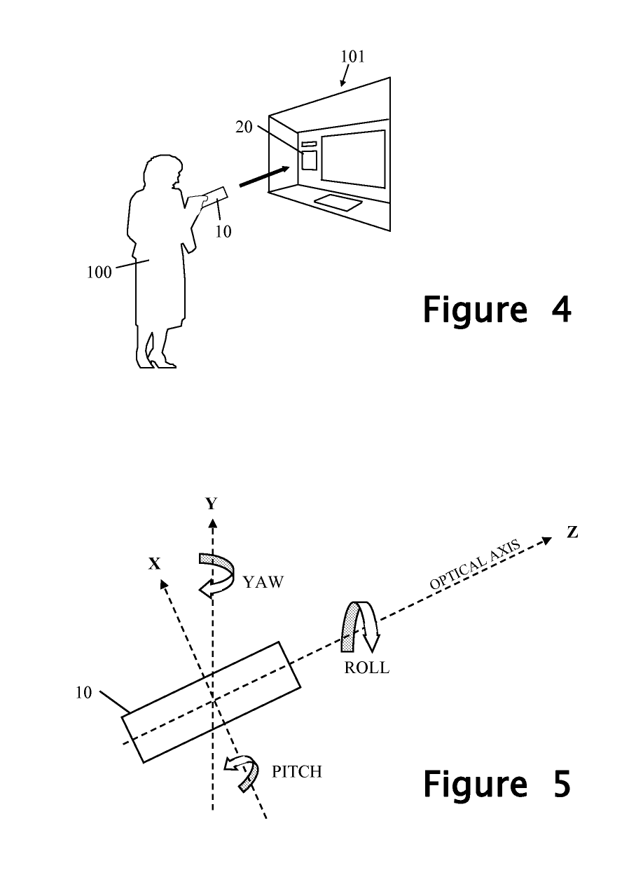

The device 10, which for example is similar in constitution to the apparatus of FIG. 2, has six degrees of freedom, namely three translational degrees of freedom each along a respective one of the axes X, Y and Z and three rotational degrees of freedom each about a respective one of the axes X, Y and Z. In the present specification, rotation about the X axis is referred to as “pitch”, rotation about the Y axis is referred to as “yaw”, and rotation about the Z axis is referred to as “roll”.

Ideally, the longitudinal axis of the quantum signal emitted by the QKD transmitter of device 10 will be aligned with the input optical axis of a cooperating QKD receiving apparatus and the polarization axes of the signal and the detector of the QKD receiving apparatus will be in angular alignment. Absent any intervening compensatory mechanism, this would require the optical and polarization axes of the QKD transmitting device 10 to be aligned with the optical and polarization axes of the QKD receiving apparatus, the only unconstrained degree of freedom of the device being translation along the Z axis (though, of course, there are limits as to how far away the device 10 can be moved from the receiving apparatus 20). Such a tight requirement on the positioning and orientation of the QKD transmitting device 10, is a practical impossibility where the device is held in the hand of a human user.

The most that can be expected of a human user is that the user points the device 10 generally at the receiving apparatus (that is, the Z axis of the device points towards the receiving apparatus). Even this will generally require some form of feedback to the user (for example, by means of a laser pointer showing where the Z axis of the device is currently intersecting the front of the receiving apparatus).

If the user were able to keep the QKD transmitting device positioned on the optical axis of the receiving apparatus while pointing at the latter (that is, no positioning errors along the X and Y axes), the only misalignments requiring compensation would be related to undesired rotation of the device 10 about the axes X, Y and Z; that is, errors in pitch, yaw and roll). However, generally when a user has the device 10 pointed at the receiving apparatus, the device will be offset along its X and Y axes from the optical axis of the receiving apparatus and the user compensates for such offsets by yaw and pitch adjustments of the device. These pitch and yaw adjustments of the device can be compensated for at the QKD receiving apparatus by making complementary adjustments, that is, by orientating the input optical axis of the receiving apparatus such that it points at the transmitting device. Such compensation does not, of course, account for pitch and yaw errors associated with inaccurate pointing of the device at the receiving apparatus.

Recapping, generally where a user seeks to interface a hand-held QKD transmitting device with a fixed QKD receiving apparatus by pointing the device at the QKD receiving apparatus, it will be necessary to implement compensatory measures in order for the quantum signal to strike the detector of the receiving apparatus along (or substantially along, that is, juxtaposed and parallel to) its optical axis with the polarization axes of the quantum signal and detector aligned. In particular, the following compensations will generally be required:
Pitch and yaw corrections to compensate for the actual angling of the transmitting device that point it at the receiving apparatus; preferably the required corrections are divided between:
   (a) Pitch and yaw corrections for compensating for the ideal angling of the device that would accurately point the device at the receiving apparatus—as already mentioned, these corrections can be effected by aligning the input optical axis of the receiving apparatus such that it points directly at the transmitting device (this type of alignment/misalignment is referred to below as “receiver-pointing alignment/misalignment”); and
   (b) Pitch and yaw corrections for compensating for inaccuracy in angling the device to point at the receiving apparatus (this type of alignment/misalignment is referred to below as “transmitter-pointing alignment/misalignment”);
Angular (roll) correction of the polarization axes of the quantum signal or detector such that the polarization axes of the signal and detector are angularly aligned (this type of alignment/misalignment is referred below to as “polarization alignment/misalignment”).

To effect such compensation, an alignment correction system can be provided, preferably with at least the majority of its active elements in the fixed receiving apparatus; the above mentioned US published application 20070025551 discloses an example of such an alignment correction system.

An alignment correction system comprises, at least conceptually:
a misalignment measuring sub-system for taking measures of the alignment corrections required, and
a misalignment compensation sub-system for effecting the required alignment corrections using an appropriate alignment compensator for each type of alignment correction to be effected.
   In a preferred implementation, the misalignment measuring subsystem is arranged to take measurements in respect of an alignment beam that is constrained to follow substantially the same optical channel as the quantum signal between the QKD transmitting and receiving apparatus; this permits measurements to be taken that are indicative of misalignment of the quantum signal but using a beam that is more easily measured (in particular, is stronger) than the quantum signal. The required alignment corrections indicated by the measurements taken in respect of the alignment beam are then applied using alignment compensators that effect the alignment of the quantum signal relative to the detector; one or more of such alignment corrections may also impact the alignment beam in which case, for the or each type of alignment concerned, the misalignment measurement sub-system and the misalignment compensation sub-system form a closed loop system (as opposed to an open loop system which would be the case if the applied correction did not affect the alignment beam).

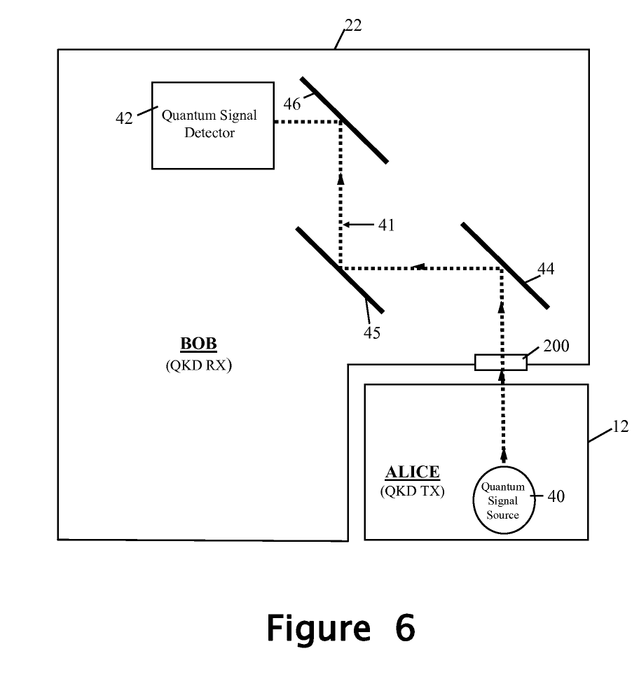

Having reviewed the considerations applicable to an alignment correction system for a hand-held QKD transmitting device and cooperating QKD receiving apparatus, a preferred embodiment of such an alignment correction system will now be described with reference to FIGS. 6 to 9. These Figures each depict various components both of:
a QKD transmitter 12 of a hand-held QKD transmitting device (“Alice”), and
a QKD receiver 22 of QKD receiving apparatus (“Bob”).

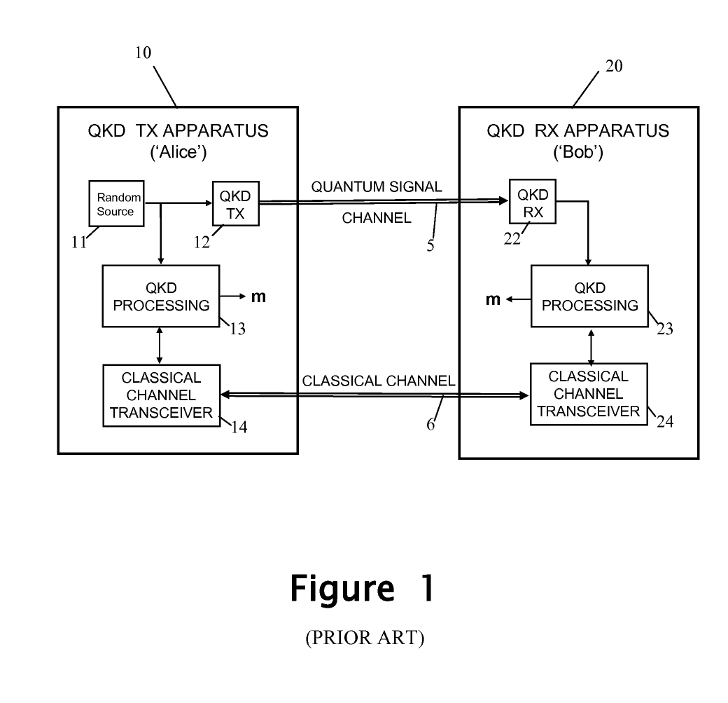

The other elements of Alice and Bob (corresponding to elements 11, 13, 14, 23 & 24 of FIG. 1) are not illustrated as they are not directly relevant to the alignment correction system to be described; such elements can for example, take the form described in the above mentioned US published application 20070025551.

FIG. 6 illustrates the path 41 taken by a quantum signal (depicted by a bold dotted line in FIGS. 6-9) between a quantum signal source 40 of QKD transmitter 12 and quantum signal detector 42 of QKD receiver 22; for clarity, the main elements involved are all referenced in the range 40-49. The quantum signal source 40 can, for example be formed by elements corresponding to elements 15-17 of FIG. 2, and the quantum signal detector 42 can take the same form as the quad detector 30 of FIG. 3; other forms of the quantum signal source 40 and quantum signal detector 42 are also possible as will be well understood by persons of ordinary skill in the art,

The quantum signal from the source 40 enters the QKD receiver 22 through an optical port 200 and is guided along an optical channel defined by optical components (in this embodiment, three mirrors 44-46) to the quantum signal detector 42. As will be more fully described below, the mirrors 44 and 46 are tip-tilt mirror (that is rotatable about two orthogonal axes lying in the plane of the mirror); the mirror 45 is a dichroic beam splitter, reflecting the quantum signal photons but passing photons of an alignment beam. The optical channel along which the quantum signal passes between the optical port 200 and detector 42 can be differently arranged from that depicted in FIGS. 6-9 by the use of suitable optical components; however, as will become clear below, at least some of the optical components defining this channel are adjustable and form part of the misalignment compensation subsystem (described hereinafter).

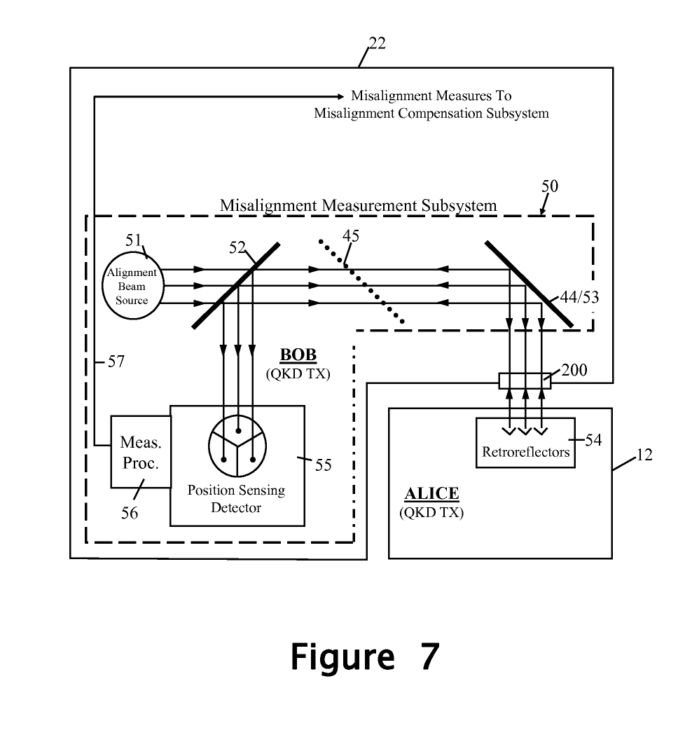

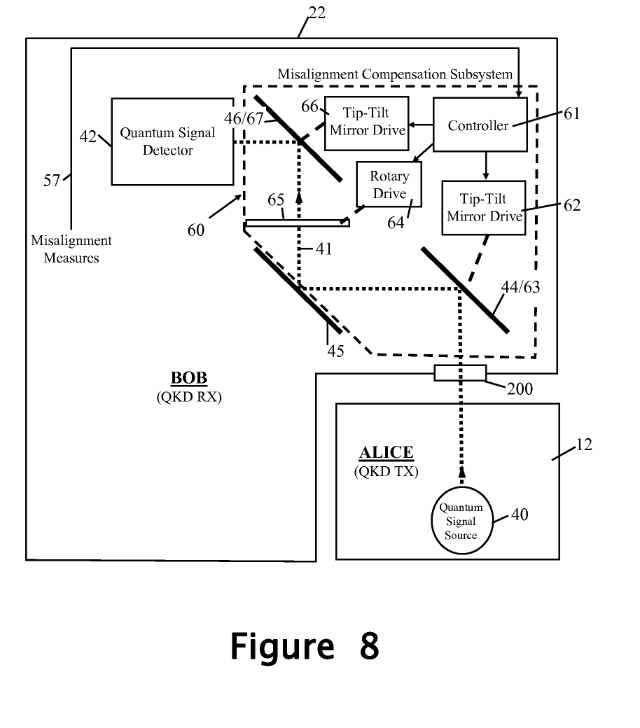

The QKD receiver 22 is provided with an alignment correction system comprising a misalignment measuring sub-system 50 for taking measures of the alignment corrections required to optimize the entry of the quantum signal to the detector 42, and a misalignment compensation sub-system 60 for effecting the required alignment corrections using an appropriate alignment compensator for each type of alignment correction to be effected. The misalignment measuring subsystem 50 and the misalignment compensation sub-system 60 are respectively depicted in FIGS. 7 and 8, the other components of the QKD receiver being omitted except where they form an integral part of the subsystem illustrated. For clarity, the main components of the misalignment measuring subsystem 50 are all referenced in the range 51-59 and the main components of the misalignment compensation subsystem 60 are all referenced in the range 61-69. Components which form both an integral part of one of the subsystem 50/60 as well as serving to define the optical channel for the quantum signal, are shown with two references, one indicating membership of the subsystem 50/60 concerned and the other being the reference given in FIG. 6 (in fact, one component, the tip-tilt mirror 44 of FIG. 6, forms an integral part of both the subsystem 50 and the subsystem 60 and accordingly has three associated references 44, 53, 63).

The misalignment measuring sub-system 50 (FIG. 7) functions by sending an alignment beam from the QKD receiver 22 generally in the direction in which the receiver is ‘looking’, and detecting features of the returned beam after reflection by a retro-reflector 54 of the QKD transmitter 12. The direction in which the QKD receiver 22 is looking (a.k.a. the pointing direction of the receiver) corresponds to the alignment of the optical axis of the quantum-signal channel at the optical port 200, this being defined by the orientation of the optical axis of the detector and the geometry of the optical components 44-46 defining the quantum-signal channel; in particular, the alignment of the optical axis of the quantum-signal channel at the optical port 200 is set by the current angling of the tip-tilt mirror 42.

Considering the misalignment measuring sub-system 50 in more detail, an alignment beam source 51 of receiver 22 generates a bright, wide-angled alignment beam at a wavelength different to that of the quantum signal; this beam after passage through a partially transmitting mirror 52 and the dichroic beam splitter 45 (transparent at the wavelength of the alignment beam), is reflected by mirror 53 (the mirror 42 of FIG. 6) out through the optical port 200.

Assuming the QKD transmitter 12 is roughly in the expected direction from the QKD receiver 22, a portion of the alignment beam will strike the transmitter and be reflected by retro-reflector 54 back to the transmitter 20. As is well known, a retro-reflector is a device or surface that reflects a wave front back along a vector that is parallel to but opposite in direction from the angle of incidence; a number of different forms of retro-reflection units are known (for example, a corner cube with a set of three mutually perpendicular mirrors that form a corner). In the present embodiment, the retro-reflector 54 actually comprises three retro-reflection units arranged in a predetermined configuration, for example an isosceles triangle, when viewed along the optical axis of the transmitter 20 (that is, the direction of emission of the quantum signal a.k.a. the direction of pointing of the transmitter 20); as a result, the reflected alignment beam is actually made up of three sub-beams that give the overall beam a predetermined cross-sectional pattern which corresponds to said predetermined configuration when the retro-reflected beam returned to the receiver 22 is aligned with the direction of pointing of the transmitter; more generally, the cross-sectional pattern presented by the retro-reflected alignment beam will be dependent both on the aforesaid predetermined configuration of the retro-reflection units, and on any offset between the direction of pointing of the transmitter and the actual direction to the receiver, that is, any transmitter pointing misalignment.

The retro-reflected beam returned to the receiver 22 enters the optical port 200 and, after reflection by the mirror 53/44 and passage through the dichroic beam splitter 45, is reflected by the partially transmitting mirror 52 to strike a position-sensing detector 55. The detector 55 is part of a detector arrangement that further comprises a measurement processor 56 for processing the output of the detector 55 to generate several different misalignment measures.

More particularly, by determining where each of the three alignment sub-beams strikes the detector 55, the detector arrangement is arranged to generate on output 57 signals indicative of each of the following three misalignment measures:
Receiver-pointing misalignment measure—this is a measure of the offset between the pointing direction of the receiver 22 and a reference direction corresponding to the actual direction from the receiver optical port 200 to the transmitter 12. This measure is determined as the difference between an averaged incident location of the three sub-beams of the detector 55 relative to a reference location (which is where the averaged location would be if the receiver was pointing directly at the transmitter).
Transmitter-pointing misalignment measure—this is a measure of the offset between the pointing direction of the transmitter 12 and the actual direction from the transmitter 12 to the receiver optical port 200 (i.e. pitch and yaw alignment errors in pointing the transmitter at the receiver). This measure is determined as an evaluation of the distortion exhibited by the pattern created by the points of incidence of the three sub-beams on the detector 55 (that is, the cross-section pattern of the retro-reflected alignment beam in the detection plane of detector 55) relative to a reference pattern corresponding to the aforesaid predetermined configuration of the three retro-reflection units 54 of the transmitter 12 (as noted above, the cross-sectional pattern of the retro-reflected alignment beam is dependent on any transmitter-pointing misalignment).
Polarization misalignment measure—this is a measure of the angular offset between the polarization axes of the transmitter and receiver (i.e. roll alignment error of the transmitter relative to the receiver). This measure is determined by comparing the orientation of the pattern created by the points of incidence of the three sub-beams on the detector 55 relative to a reference orientation (corresponding, for example, to alignment of the polarization axes of the transmitter and receiver). Preferably the aforesaid predetermined configuration of the three retro-reflection units of the transmitter has at least one asymmetry to facilitate determination of the orientation of the detector incidence pattern; it is to be noted that any alignment between the polarization axes of the transmitter and receiver is acceptable and such alignments occur every 180°—thus, the predetermined configuration could be an equilateral triangle.

The misalignment measures are passed to a controller 61 of the misalignment compensation sub-system 60 (FIG. 8), this controller being typically formed by a program-controlled processor that preferably also serves as the measurement processor 56. In addition to the controller 61, the misalignment compensation sub-system 60 comprises a receiver-pointing misalignment compensator 63 with its associated drive 62, a transmitter-pointing misalignment compensator 67 with its associated drive 66, and a polarization misalignment compensator 63 and its associated drive 64.

The receiver-pointing misalignment compensator 63 serves as one of the optical components defining the quantum-signal optical channel (in this case the tip-tilt mirror 44) and controls the direction of pointing of the longitudinal axis of the quantum-signal optical channel at the receiver optical port 200 (that is, the direction of pointing of the receiver). The angling of the compensator 63 (tip-tilt mirror 44) is set by the drive 62, the latter being controlled by the controller 61 in dependence on the receiver-pointing misalignment measure from subsystem 50 such as to point the receiver 22 at the transmitter 12. In the present embodiment, as adjusting the direction of pointing of the receiver by adjusting the angling of the compensator 63, affects not only the incoming quantum signal but also the alignment beam, the elements that measure the receiver-pointing misalignment and compensate for this misalignment form a closed-loop control system with the misalignment measure reducing to zero as the compensator 63 is adjusted to point the receiver at the transmitter. Although not preferred, it would alternatively be possible to arrange for the alignment beam to be unaffected by the compensator 63 resulting in open-loop control of the latter.

The transmitter-pointing misalignment compensator 67 serves as another of the optical components defining the quantum-signal optical channel (in this case the tip-tilt mirror 46) and controls the direction of pointing of the longitudinal axis of the quantum-signal optical channel at the quantum-signal detector 42. The angling of the compensator 67 (tip-tilt mirror 46) is set by the drive 66, the latter being controlled by the controller 61 in dependence on the transmitter-pointing misalignment measure from subsystem 50 such that the quantum signal strikes the detector 42 substantially orthogonally. In the present embodiment, as adjusting the angling of the compensator 67 does not affect the alignment beam, the elements that measure the transmitter-pointing misalignment and compensate for this misalignment form an open-loop control system with the misalignment measure being unaffected by adjustment of the compensator 67. It would alternatively be possible to provide a closed-loop control system for the compensator 67 by, for example, mounting the position sensing detector 55 on a tip-tilt table mechanically coupled to tip/tilt with the tip-tilt mirror forming the compensator 67. Furthermore, rather than the transmitter-pointing misalignment compensator 67 being formed by one of the optical components defining the path 41, the transmitter-pointing misalignment compensator 67 can be implemented as an arrangement for adjusting the direction of pointing of the optical axis of the quantum-signal detector 42.

The polarization misalignment compensator 65 takes the form of a polarization rotator (for example, a half-wave plate) located in the quantum-signal optical channel and controls the orientation of the axes of polarization of the quantum signal arriving at the detector 42. The angling of the compensator 65 is set by the drive 64, the latter being controlled by the controller 61 in dependence on the polarization misalignment measure from subsystem 50 such that the polarization axes of the quantum signal entering the detector 42 are aligned with the polarization axes of the detector 42. In the present embodiment, as adjusting the compensator 65 has no effect on the sub-beam incidence pattern at the position-sensing detector 55, the elements that measure the polarization misalignment and compensate for this misalignment form an open-loop control system with the misalignment measure being unaffected by adjustment of the compensator 65. It would alternatively be possible to provide a closed-loop control system for the compensator 65 by, for example, arranging for the position-sensing detector 55 to rotate in its plane in coordination with rotation of the polarization rotator forming the compensator 65. Furthermore, rather than the polarization misalignment compensator 65 being formed by a polarization rotator located in the path 41, the polarization misalignment compensator 67 can be implemented as an arrangement for rotating the quantum-signal detector 42 to adjust the orientation of its polarization axes.

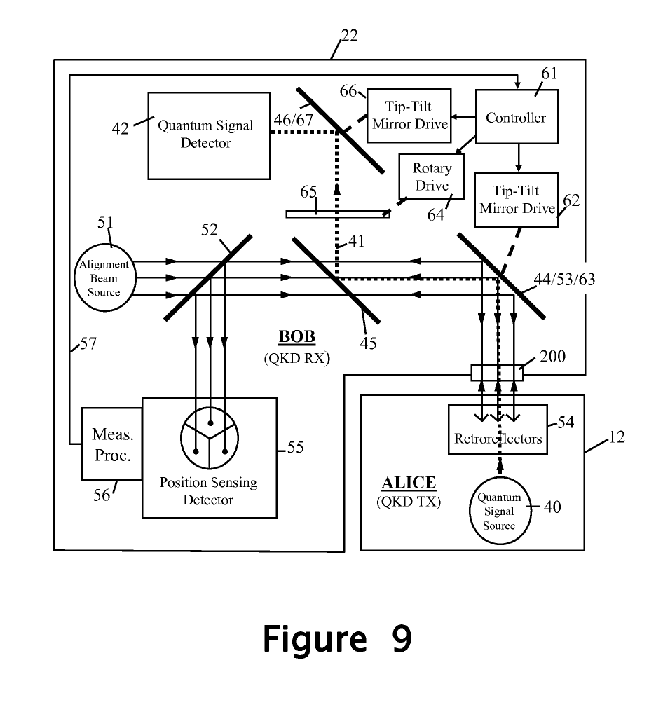

FIG. 9 brings together the receiver quantum-signal optical channel components of FIG. 6, the misalignment measuring subsystem of FIG. 7, and the misalignment compensation subsystem of FIG. 8, showing the complete alignment correction system that serves to compensate for transmitter-pointing misalignment, receiver-pointing misalignment and polarization misalignment between the QKD transmitter 20 and the QKD receiver 22.

It will be appreciated that many variants are possible to the above described embodiment of the invention. For example, the number and configuration of the individual retro-reflection units making up the retro-reflector 54 can be varied; indeed, the division of the alignment beam into multiple sub-beams with a predetermined cross-sectional pattern can be effected at the receiver 22 on the outgoing beam (for example, using a beam splitter or providing separate sources for each sub-beam) in which case the retro-reflector 54 need only comprise a single retro-reflection unit.

Furthermore, the configuration of the paths followed by the alignment beam and the quantum signal within the receiver 22 can be varied from that described above.

1. QKD receiving apparatus comprising:
an optical input/output port;
a quantum-signal detector;
first optical components for guiding a quantum signal of polarized photons received at the optical port, along a first optical channel to the quantum-signal detector; and
an alignment-correction system for correcting misalignment of the quantum signal relative to the quantum-signal detector, the alignment-correction system comprising a misalignment measuring subsystem for making multiple different misalignment measures, and a misalignment compensation subsystem for adjusting the relative alignment of the quantum signal and quantum-signal detector in dependence on the misalignment measures made; the misalignment measuring subsystem comprising:
an alignment-beam source;
an alignment-beam detector arrangement for making multiple different misalignment measures; and
second optical components for guiding an alignment beam from the alignment-beam source to the optical port, and for guiding the alignment beam, after external retro-reflection, from the optical port to the alignment-beam detector arrangement.

2. Apparatus according to claim 1, wherein the first and second optical components have at least one component in common including a beam splitter for separating the retro-reflected alignment beam received back through the optical port from the quantum signal received at the optical port, the second optical components further including a component for causing the retro-reflected alignment beam to follow a path different to the outgoing alignment beam and taking it to the alignment-beam detector arrangement.

3. Apparatus according to claim 2, wherein the alignment beam source is arranged to generate the alignment beam as multiple sub-beams imparting a predetermined cross-sectional shape to the alignment beam, the alignment-beam detector arrangement being arranged to compare the cross-sectional shape of the retro-reflected alignment beam with said predetermined cross-sectional shape in order to determine at least one of said multiple different alignment measures.

4. Apparatus according to claim 2, wherein:
the alignment-beam detector arrangement is arranged to determine a receiver-pointing misalignment measure in dependence on an angular offset of the retro-reflected alignment beam relative to a reference direction;
the misalignment compensation subsystem comprises a controller, and a receiver-pointing misalignment compensator serving as a said first optical component and controlling the direction of pointing of the longitudinal axis of the first optical channel at the input port; and
the controller of the misalignment compensation subsystem is adapted to control the receiver-pointing misalignment compensator in dependence on the receiver-pointing misalignment measure such that with the alignment beam retro-reflected by a transmitter of the quantum signal, the longitudinal axis of the first optical channel at the optical port points towards the quantum signal transmitter.

5. Apparatus according to claim 4, wherein said reference direction is arranged to vary with the direction of pointing of the longitudinal axis of the first optical channel at the optical port by arranging for the receiver-pointing misalignment compensator also to serve as a said second optical component whereby said angular offset is reduced to zero when the retro-reflected alignment beam passes back through the optical port along the longitudinal axis of the first optical channel.

6. Apparatus according to claim 2, wherein:
the alignment-beam detector arrangement is arranged to determine a transmitter-pointing misalignment measure in dependence on the cross-sectional shape of the retro-reflected alignment beam in a detecting plane of the alignment-beam detector arrangement relative to a reference cross-sectional shape;
the misalignment compensation subsystem comprises a controller, and a transmitter-pointing misalignment compensator serving as a said first optical component and controlling the direction of pointing of the longitudinal axis of the first optical channel at the quantum-signal detector; and
the controller of the misalignment compensation subsystem is adapted to control the transmitter-pointing misalignment compensator in dependence on the transmitter-pointing misalignment measure such that with the alignment beam retro-reflected by a transmitter of the quantum signal, the quantum signal is substantially parallel to the optical axis of the quantum-signal detector.

7. Apparatus according to claim 6, wherein the alignment beam detector is arranged to detect the cross-sectional shape of the retro-reflected alignment beam as the pattern established by component sub-beams of the retro-reflected alignment beam.

8. Apparatus according to claim 7, wherein the alignment beam source is arranged to form the alignment beam as multiple sub beams with a predetermined cross-sectional pattern.

9. Apparatus according to claim 2, wherein:
the alignment-beam detector arrangement is arranged to determine a transmitter-pointing misalignment measure in dependence on the cross-sectional shape of the retro-reflected alignment beam in a detecting plane of the alignment-beam detector arrangement relative to a reference cross-sectional shape;
the misalignment compensation subsystem comprises a controller, and a transmitter-pointing misalignment compensator for adjusting the direction of pointing of the optical axis of the quantum-signal detector; and
the controller of the misalignment compensation subsystem is adapted to control the transmitter-pointing misalignment compensator in dependence on the transmitter-pointing misalignment measure such that with the alignment beam retro-reflected by a transmitter of the quantum signal, the quantum signal is substantially parallel to the optical axis of the quantum-signal detector.

10. Apparatus according to claim 9, wherein the alignment beam detector is arranged to detect the cross-sectional shape of the retro-reflected alignment beam as the pattern established by component sub-beams of the retro-reflected alignment beam.

11. Apparatus according to claim 10, wherein the alignment beam source is arranged to form the alignment beam as multiple sub beams with a predetermined cross-sectional pattern.

12. Apparatus according to claim 2, wherein:
the alignment-beam detector arrangement is arranged to determine a polarization misalignment measure in dependence on the angular orientation of an angularly non-uniform cross-sectional shape of the retro-reflected alignment beam in a detecting plane of the alignment-beam detector arrangement, relative to a reference orientation;
the misalignment compensation subsystem comprises a controller, and a polarization misalignment compensator lying in said first optical channel and controlling the orientation of axes of polarization of the quantum signal; and
the controller of the misalignment compensation subsystem is adapted to control the polarization misalignment compensator in dependence on the polarization misalignment measure such that with the alignment beam retro-reflected by a transmitter of the quantum signal, the axes of polarization of the quantum signal are aligned with polarization axes of the quantum-signal detector.

13. Apparatus according to claim 2, wherein:
the alignment-beam detector arrangement is arranged to determine a polarization misalignment measure in dependence on the angular orientation of an angularly non-uniform cross-sectional shape of the retro-reflected alignment beam in a detecting plane of the alignment-beam detector arrangement, relative to a reference orientation;
the misalignment compensation subsystem comprises a controller, and a polarization misalignment compensator for rotating the quantum-signal detector to adjust the orientation of its polarization axes; and
the controller of the misalignment compensation subsystem is adapted to control the polarization misalignment compensator in dependence on the polarization misalignment measure such that with the alignment beam retro-reflected by a transmitter of the quantum signal, polarization axes of the detector are aligned with the axes of polarization of the quantum signal.

14. A QKD system comprising QKD receiving apparatus according to claim 1 and QKD transmitting apparatus, the QKD transmitting apparatus comprising a quantum-signal transmitter and a retro-reflector for retro-reflecting the alignment beam emitted by the QKD receiver.

15. A QKD system according to claim 14, wherein the retro-reflector comprises multiple retro-reflection units whereby the retro-reflected alignment beam comprises multiple sub beams imparting a predetermined cross-sectional shape to the retro-reflected alignment beam, the alignment-beam detector arrangement being arranged to compare the cross-sectional shape of the retro-reflected alignment beam with said predetermined cross-sectional shape in order to determine at least one of said multiple different alignment measures.

16. QKD transmitting apparatus comprising a quantum-signal transmitter and a retro-reflector for retro-reflecting an alignment beam emitted by QKD receiving apparatus, the retro-reflector comprises multiple retro-reflection units whereby the retro-reflected alignment beam comprises multiple sub beams, the retro-reflection units being arranged to impart a predetermined cross-sectional shape to the retro-reflected alignment beam.
